(19) United States
(12) Patent Application Publication
(10) Pub. No.: US 2025/0215952 A1
(43) Pub. Date: Jul. 3, 2025

(54) MOUNT AND ELECTRIC VEHICLE INCLUDING THE SAME

(71) Applicants: HYUNDAI MOTOR COMPANY, Seoul (KR); KIA CORPORATION, Seoul (KR)

(72) Inventors: Gu Gyun KWON, Hwaseong-si (KR); Jae Hyung YUN, Hwaseong-si (KR); Young Deuk SEO, Hwaseong-si (KR)

(73) Assignees: HYUNDAI MOTOR COMPANY, Seoul (KR); KIA CORPORATION, Seoul (KR)

(21) Appl. No.: 18/958,124

(22) Filed: Nov. 25, 2024

(30) Foreign Application Priority Data
Dec. 28, 2023 (KR) 10-2023-0193921

(51) Int. Cl. F16F 13/06; B60K 1/00

(52) U.S. Cl. CPC F16F 13/06; B60K 1/00; F16F 2222/08; F16F 2222/12; F16F 2226/04

(57) ABSTRACT

A mount is configured to mount a motor module of an electric vehicle. The mount includes a hydro mass damper capable of being assembled with a rubber bush, and the hydro mass damper includes a fluid flowing through an inside of the hydro mass damper according to vibration applied to the hydro mass damper.

### CROSS-REFERENCE TO RELATED APPLICATION

This application claims, under 35 U.S.C. §119(a), the benefit of priority from Korean Patent Application No. 10-2023-0193921, filed on Dec. 28, 2023, the entire contents of which are incorporated herein by reference.

### TECHNICAL FIELD

The present disclosure relates to a vehicle mount, and more particularly, to a mount configured to mount a motor module of an electric vehicle.

### BACKGROUND

Recently, research and development has been actively conducted on eco-friendly electric vehicles. Electric vehicles are driven by motors instead of conventional engines and are powered by rechargeable batteries.

A motor module including motors and power electronics (PE) weighs less than an existing engine. Accordingly, the motor module is usually mounted on a vehicle using a rubber bush type motor mount instead of a hydraulic mount.

Referring to FIG. 1, a motor mount 1200 for a motor module supports the motor module and serves to isolate vibration transmitted from the motor module to a vehicle body. The motor mount 1200 connects the vehicle body or a cross member 1220 with a PE housing 1240 having the motor module accommodated therein. The motor mount 1200 may be press-fitted into the vehicle body or the cross member 1220 and may be coupled to the PE housing 1240 through a bolt 1260.

The rubber bush type motor mount 1200 has lower axial (A1) characteristics than characteristics in other directions, and the motor module is usually installed on a rear wheel of a vehicle. Accordingly, when a vehicle passes a bump, secondary residual vibration occurs. Secondary residual vibration causes deterioration in ride comfort of a vehicle.

The above information disclosed in this Background section is only for enhancement of understanding of the background of the disclosure, and therefore it may contain information that does not form the prior art that is already known to a person of ordinary skill in the art.

### SUMMARY OF THE DISCLOSURE

The present disclosure has been made in an effort to solve the above-described problems associated with the prior art, and it is an object of the present disclosure to provide a mount for an electric vehicle, capable of reducing residual vibration and effectively isolating noise and vibration.

The objects of the present disclosure are not limited to the above-mentioned objects, and other technical objects not mentioned herein will be clearly understood by those skilled in the art to which the present disclosure pertains from the detailed description of the embodiments.

In one aspect, a mount includes a hydro mass damper capable of being assembled with a rubber bush, and the hydro mass damper includes a fluid flowing through an inside of the hydro mass damper according to vibration applied to the hydro mass damper.

In another aspect, a mount includes a rubber bush mounted on a vehicle body of a vehicle, and a hydro mass damper detachably coupled to the rubber bush, in which the hydro mass damper is mounted on a structure to connect the structure to the vehicle body.

In still another aspect, a vehicle includes the mount.

Other aspects and preferred embodiments of the disclosure are discussed infra.

It is understood that the terms “vehicle,” “vehicular,” and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is an example motor mount connecting a motor module of a vehicle to a vehicle body;

FIG. 2 is an exploded perspective view of a mount according to an embodiment of the present disclosure;

FIG. 3 is a perspective view of the mount according to an embodiment of the present disclosure;

FIG. 4 is an exploded perspective view of a hydro mass damper of the mount according to an embodiment of the present disclosure;

FIG. 5 is a cross-sectional view taken along line C1-C1 in FIG. 2;

FIG. 6 is a cross-sectional view of a state in which the hydro mass damper of the mount according to an embodiment of the present disclosure is mounted on a PE housing;

FIG. 7 is a cross-sectional view taken along line C2-C2 in FIG. 3;

FIG. 8 is a cross-sectional view of the hydro mass damper of the mount according to an embodiment of the present disclosure, in which S1 shows a state in which the hydro mass damper is not coupled to a connection member, and S2 shows a state in which the hydro mass damper is coupled to the connection member; and

FIGS. 9, 10, and 11 are diagrams showing an assembly process of the hydro mass damper of the mount according to an embodiment of the present disclosure.

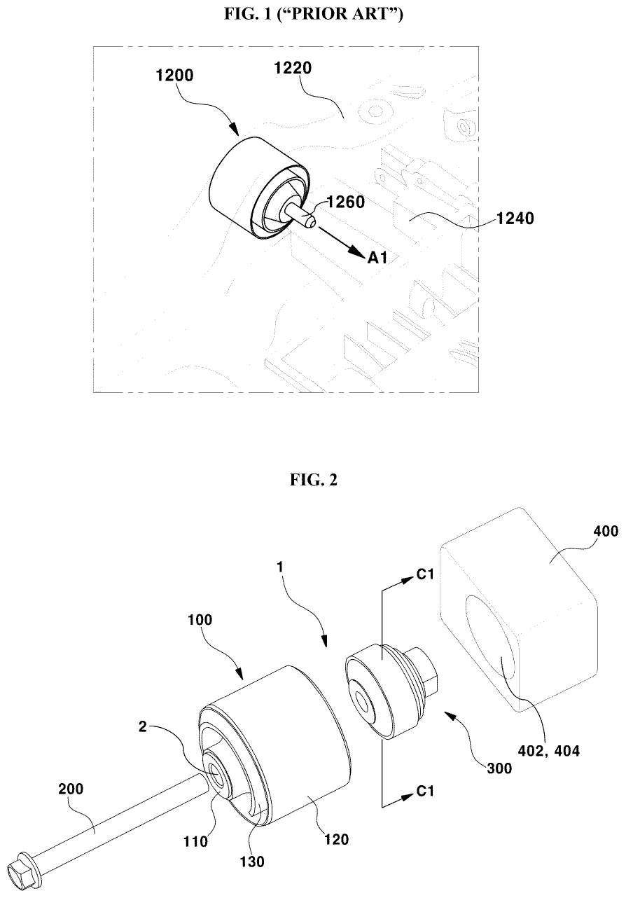

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Specific structural or functional descriptions given in connection with the embodiments of the present disclosure are merely illustrative for the purpose of describing embodiments according to the concept of the present disclosure, and the embodiments according to the concept of the present disclosure may be implemented in various forms. Further, it will be understood that the present description is not intended to limit the disclosure to the embodiments. On the contrary, the disclosure is intended to cover not only the embodiments, but also various alternatives, modifications, equivalents, and other embodiments, which may be included within the spirit and scope of the disclosure as defined by the appended claims.

Meanwhile, in the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, that is, “between” and “directly between” or “adjacent to” and “directly adjacent to,” should be interpreted in the same manner.

The same reference numerals represent the same components throughout the specification. Additionally, the terms in the specification are used merely to describe embodiments, and are not intended to limit the present disclosure. In this specification, an expression in a singular form also includes a plural form, unless clearly specified otherwise in context. As used herein, expressions such as “comprise” and/or “comprising” do not exclude the presence or addition of one or more components, steps, operations, and/or elements other than those described.

Hereinafter, the present disclosure will be described in detail with reference to the attached drawings.

To solve the above-described problem, a hydraulic mount may be considered in order to alleviate residual vibration caused by a rubber mount. The hydraulic mount may damp vibration through a flow of fluid enclosed inside the hydraulic mount.

To use the hydraulic mount as a mount to support a motor, several issues need to be addressed. First, in the hydraulic mount, fluid stoppage may occur above a specific frequency. Stopping phenomenon of an incompressible fluid may increase dynamic characteristics of the hydraulic mount. Additionally, since the hydraulic mount includes a fluid operation portion, an amount of rubber is insufficient compared to the rubber mount, which causes deterioration in vibration isolation performance. Overall, increased dynamic characteristics and deterioration in vibration isolation performance may result in deterioration in NVH (noise, vibration, and harshness) performance of vehicles.

Accordingly, the present disclosure provides a mount including a hydro mass damper capable of being detached from or assembled with a rubber bush, thereby making it possible not only to improve ride and handling (R&H) performance by alleviating residual vibration but also to improve NVH performance.

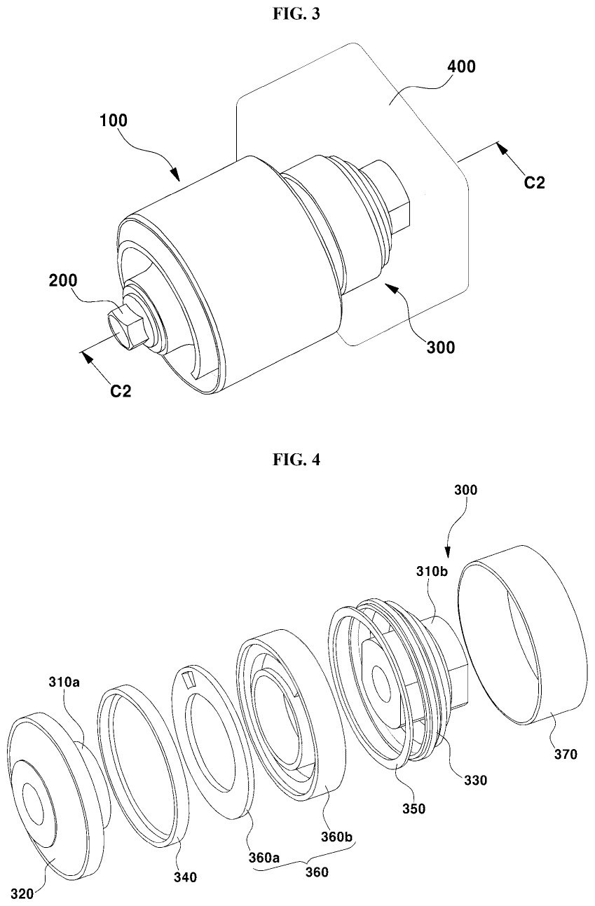

As shown in FIGS. 2 and 3, according to the present disclosure, a mount 1 may include a rubber bush 100 and a hydro mass damper 300. The rubber bush 100 and the hydro mass damper 300 may be assembled with each other and may be separated from each other by a connection member 200.

A hollow or aperture 2 is formed in the mount 1. The aperture 2 may extend coaxially through the rubber bush 100 and the hydro mass damper 300.

The connection member 200 is mounted in the aperture 2. The connection member 200 may penetrate the rubber bush 100 and the hydro mass damper 300. In one embodiment, the connection member 200 includes a male screw at one end portion of the connection member 200. As described below, the male screw may be thread-coupled to a second inner core 310b of the hydro mass damper 300. The other end portion of the connection member 200 may include a flange protruding radially outward. The flange may mate with the rubber bush 100, so the position of the connection member 200 may be fixed.

The rubber bush 100 may be mounted on the vehicle body or the cross member 1220. In one example, the rubber bush 100 may be press-fitted into the cross member 1220.

The rubber bush 100 includes an inner pipe 110, an outer pipe 120, and a rubber 130. The inner pipe 110 and the outer pipe 120 are concentrically disposed. The outer pipe 120 may be disposed outside the inner pipe 110. The rubber 130 may be vulcanized between the inner pipe 110 and the outer pipe 120.

The hydro mass damper 300 may be assembled with the rubber bush 100. Additionally, the hydro mass damper 300 may be coupled to a PE housing 400. For example, the hydro mass damper 300 may be press-fitted into the PE housing 400. A motor and power electronics module configured to drive a vehicle may be accommodated in the PE housing 400. The PE housing 400 may be connected to the vehicle body or the cross member 1220 through the hydro mass damper 300 and the rubber bush 100.

In one embodiment, the hydro mass damper 300 may be assembled to the PE housing 400 through receiving portions 402 and 404 provided in the PE housing 400. In one example, the receiving portions 402 and 404 include a first receiving portion 402 that accommodates at least a portion of the hydro mass damper 300. In one example, the receiving portions 402 and 404 may include a second receiving portion 404 arranged to prevent rotation of the hydro mass damper 300. In one example, a flat, non-curved surface 410 may be formed on at least a part of the circumference of the second receiving portion 404 to prevent rotation of the hydro mass damper 300.

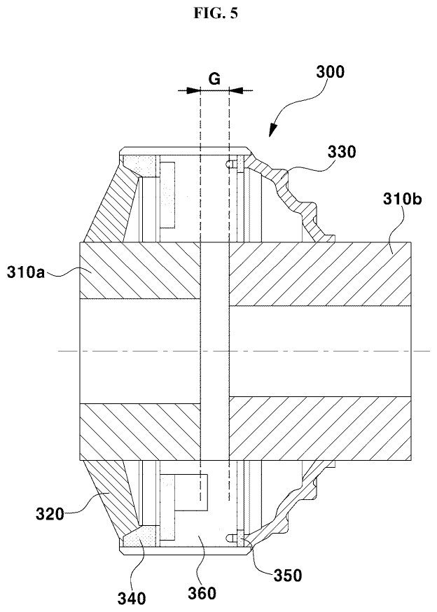

As shown in FIG. 4, the hydro mass damper 300 may include two cores 310a and 310b separated from each other or a housing. The housing may include a first housing (310a, 320, and 340) and a second housing (310b, 330, and 350). A fluid may be enclosed in the hydro mass damper 300 by the two housings.

The first housing 310a, 320, and 340 includes a first inner core 310a, a rubber portion 320, and a first ring 340. The first inner core 310a and the first ring 340 are concentrically disposed. The rubber portion 320 may be vulcanized with respect to the first inner core 310a and the first ring 340. In one example, the first inner core 310a may be made of aluminum. In one example, the first ring 340 may be made of steel.

The second housings 310b, 330, and 350 include a second inner core 310b, a diaphragm 330, and a second ring 350. The second inner core 310b and the second ring 350 are concentrically disposed. The diaphragm 330 which is contractable or expandable by an external force may be vulcanized between the second inner core 310b and the second ring 350. In one example, the second inner core 310b may be made of aluminum. In one example, the second ring 350 may be made of steel. As a non-limiting example, the diaphragm 330 may be made of a rubber material. The diaphragm 330 may be made of a rubber material having a lower rigidity than that of the rubber portion 320.

Referring to FIG. 5, according to one embodiment of the present disclosure, a female screw is formed on the inner peripheral surface of the second inner core 310b. The female screw may be screwed to the connection member 200. In particular, the female screw formed on the second inner core 310b may be screwed to the male screw formed on the connection member 200.

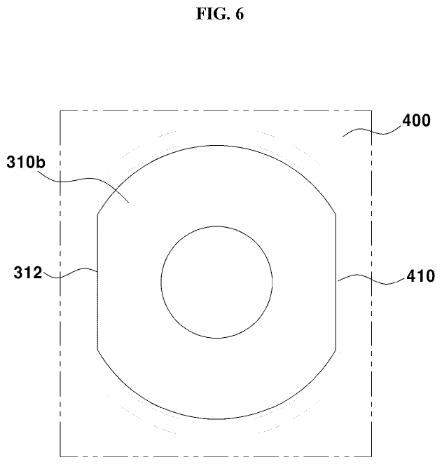

As shown in FIG. 6, the second inner core 310b may include a flat surface 312 on at least a part of the outer peripheral surface thereof. The flat surface 312 of the second inner core 310b may prevent rotation of the hydro mass damper 300 press-fitted into the PE housing 400 through coupling with the second receiving portion 404. Specifically, the flat surface 312 is mated with the non-curved surface 410, so that rotation of the hydro mass damper 300 may be prevented after the hydro mass damper 300 is inserted into the PE housing 400.

A nozzle assembly 360 is mounted on the housing. For example, the nozzle assembly 360 may be disposed between the first housings 310a, 320, and 340 and the second housings 310b, 330, and 350. A flow of fluid enclosed in the hydro mass damper 300 may be guided through the nozzle assembly 360 when an external force or vibration is applied, and the fluid may flow between the first housings 310a, 320, and 340 and the second housings 310b, 330, and 350.

In one embodiment, the nozzle assembly 360 includes a first nozzle 360a and a second nozzle 360b. A flow path 362 capable of guiding the flow of fluid may be provided in the first nozzle 360a and the second nozzle 360b. The fluid may flow between the first housings 310a, 320, and 340 and the second housings 310b, 330, and 350 through the flow path 362. In one example, the first nozzle 360a and the second nozzle 360b may be made of plastic.

The hydro mass damper 300 further includes a sleeve 370. The sleeve 370 may be disposed to surround the outer peripheral surfaces of the first housings 310a, 320, and 340, the nozzle assembly 360, and the second housings 310b, 330, and 350. In one example, the sleeve 370 may be made of steel.

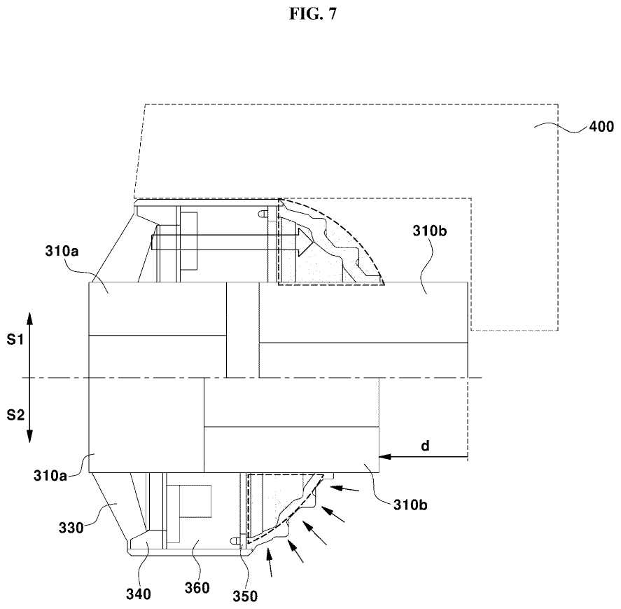

A gap G is formed between the first inner core 310a and the second inner core 310b of the hydro mass damper 300. Particularly, the gap G is formed before the hydro mass damper 300 is coupled to the connection member 200. Referring to FIG. 7, in the illustrated embodiment, a state before the hydro mass damper 300 is coupled to the connection member 200 is indicated as a portion S1.

As indicated by a portion S2 in FIG. 7, after the hydro mass damper 300 is coupled to the connection member 200, the gap G may be substantially eliminated. In other words, when the hydro mass damper 300 is coupled to the connection member 200, the second inner core 310b may be moved toward the first inner core 310a, and a size of the gap G may be reduced.

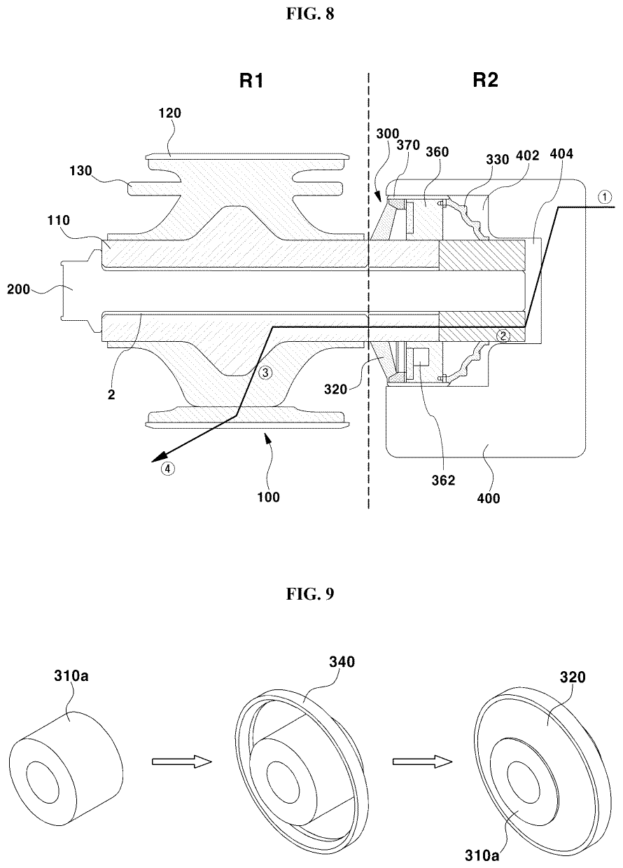

As described above, the hydro mass damper 300 is coupled to the rubber bush 100 by the connection member 200. Referring to FIG. 8, the outer pipe 120 of the rubber bush 100 is press-fitted into the vehicle body or the cross member 1220. The sleeve 370 of the hydro mass damper 300 is press-fitted and fixed to the first receiving portion 402 of the PE housing 400. When the male screw of the connection member 200 is coupled to the female screw formed on the second inner core 310b, the second inner core 310b is moved toward the first inner core 310a by screw coupling. The second inner core 310b may be moved by a moving distance d. When the second inner core 310b moves while dragging the vulcanized diaphragm 330, the volume of a fluid chamber formed in the second housings 310b, 330, and 350 may be reduced (as indicated by a plurality of arrows in FIG. 7). Accordingly, fluid density in the second housings 310b, 330, and 350 increases and, as such, pre-tension of the diaphragm 330 may be secured.

In the hydro mass damper 300, the fluid is accommodated between the rubber portion 320 and the diaphragm 330. The rubber portion 320 has high rubber rigidity in order to allow the fluid to flow through the nozzle assembly 360 when an external force is applied. On the other hand, the diaphragm 330 is configured to have lower rubber rigidity in order to accommodate the fluid that has passed through the nozzle assembly 360. Therefore, when the diaphragm 330 generally having low rigidity is expanded as accommodating the fluid, a rattling noise may occur by hitting the nozzle assembly 360 or the PE housing 400.

On the other hand, according to the present disclosure, pre-tension is formed during a coupling process of the connection member 200, thereby making it possible to prevent occurrence of the rattling noise caused by the diaphragm 330 hitting the nozzle assembly 360 or the PE housing 400.

As indicated by arrows numbers 1 through 4 in circle in FIG. 8, a vibration from the PE housing 400 indicted by the arrow number 1 in circle is transmitted to a vehicle body indicated by the arrow number 4 in circle through the hydro mass damper 300 indicated by the arrow number 2 in circle and the rubber bush 100 indicated by the arrow number 3 in circle. Since the vibration passes through the hydro mass damper 300 before passing through the rubber bush 100, the hydro mass damper 300 may serve as a mass damper of the PE housing 400 as a heavy object.

The hydro mass damper 300 may primarily reduce vibration (portion R2) as a mass damper, and the rubber bush 100 may secondarily reduce the vibration that has been damped while passing through the hydro mass damper 300 (portion R1). That is, the rubber bush 100 may be responsible for vibration isolation performance, and the hydro mass damper 300 may be responsible for damping performance. According to the present disclosure, vibration from the PE housing 400 may be primarily reduced by damping performance of the hydro mass damper 300. In addition, since the damped vibration passes through the rubber bush 100 that contains only rubber and has low dynamic characteristics, a vibration isolation rate is secondarily improved, thereby minimizing vibration entering the vehicle body.

Additionally, according to the present disclosure, the hydro mass damper 300 is separately provided from the rubber bush 100, thereby making it possible to reduce the size of the hydro mass damper 300.

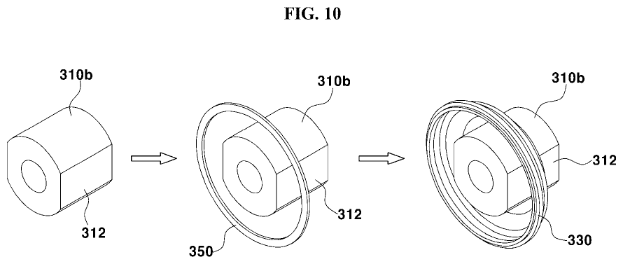

An assembly process of the mount 1 according to a part of the embodiments of the present disclosure will be described with reference to FIGS. 9 to 11.

As shown in FIG. 9, the first ring 340 is concentrically disposed with the first inner core 310a. The first housings 310a, 320, and 340 may be assembled by vulcanizing the rubber portion 320 connecting the first inner core 310a to the first ring 340.

As shown in FIG. 10, a female screw is formed on the inner peripheral surface of the second inner core 310b. Additionally, the second inner core 310b is formed to include the flat surface 312 on at least a part of the outer peripheral surface of the second inner core 310b. The second ring 350 is disposed along a concentric axis of the second inner core 310b. The second housings 310b, 330, and 350 may be formed by vulcanizing the diaphragm 330 connecting the second inner core 310b to the second ring 350.

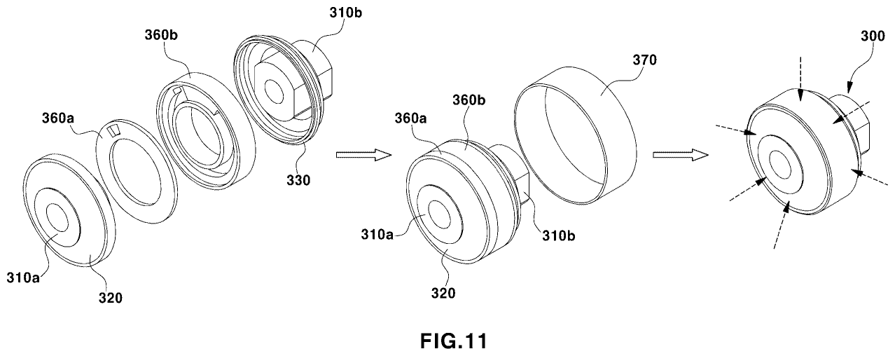

As shown in FIG. 11, the first housings 310a, 320, and 340 and the second housings 310b, 330, and 350 are assembled with the nozzle assembly 360. The assembled first housings 310a, 320, and 340, the nozzle assembly 360, and the second housings 310b, 330, and 350 are inserted into the sleeve 370. Through a swaging process performed in a liquid, and the fluid is injected into and sealed in the hydro mass damper 300, thereby completing assembly of the hydro mass damper 300.

In a conventional axial hydraulic mount, a nozzle portion and a rubber portion are assembled with each other, so dynamic characteristics inevitably increase due to a fluid stopping phenomenon. In addition, vibration isolation is reduced due to increased dynamic characteristics and an insufficient amount of rubber, which causes deterioration in NVH performance.

On the other hand, the mount according to the present disclosure may improve the NVH performance by separating a fluid operation portion (hydro mass damper) and a rubber portion (rubber bush). When vibration is introduced through the hydro mass damper 300, the introduced vibration is damped through damping performance of the hydro mass damper 300. Furthermore, since the rubber bush 100 separated from the hydro mass damper 300 contains a sufficient amount of rubber, the NVH performance may be improved by additionally isolating the damped vibration. Therefore, according to the mount of the present disclosure, both R&H and NVH performance may be improved.

In electric vehicles, since the PE or the PE housing 400 is coupled to the cross member 1220, axial coupling of the mount increases. The mount according to the present disclosure may provide a structure in which the fluid operation portion and the rubber portion may be separated from each other and may be coupled to each other in the axial direction.

The mount according to the present disclosure may be applied not only to pure electric vehicles but also to all vehicles including a motor module. Further, the mount according to the present disclosure is specifically designed to mount a motor module on a vehicle, but application of the mount according to the present disclosure is not limited to a vehicle.

As is apparent from the above description, the present disclosure provides a mount for an electric vehicle capable of reducing residual vibration and effectively isolating noise and vibration.

The effects of the present disclosure are not limited to the above-mentioned effects, and other effects not mentioned herein will be clearly understood by those skilled in the art from the detailed description of the embodiments.

The present disclosure described above is not limited to the above-described embodiments and the accompanying drawings, and it will be appreciated by those skilled in the art that various substitutions, modifications, and changes are possible in these embodiments without departing from the principles and spirit of the disclosure, the scope of which is defined in the appended claims and equivalents thereto.

What is claimed is:

1. A mount comprising a hydro mass damper capable of being assembled with a rubber bush, wherein the hydro mass damper comprises a fluid flowing through an inside of the hydro mass damper according to vibration applied to the hydro mass damper.

2. The mount of claim 1, wherein the hydro mass damper comprises:
a housing configured to accommodate the fluid in the housing; and
a nozzle assembly mounted on the housing and configured to guide movement of the fluid in the housing.

3. The mount of claim 2, wherein the housing comprises a first housing disposed on a first side of the nozzle assembly and a second housing disposed on a second side of the nozzle assembly.

4. The mount of claim 3, wherein the first housing comprises:
a first inner core;
a first ring concentrically disposed with the first inner core; and
a rubber vulcanized to connect the first inner core to the first ring.

5. The mount of claim 3, wherein the second housing comprises:
a second inner core;
a second ring concentrically disposed with the second inner core; and
a contractable or expandable diaphragm vulcanized to connect the second inner core to the second ring.

6. The mount of claim 5, wherein the second inner core has a flat surface formed on at least a part of an outer peripheral surface of the second inner core.

7. The mount of claim 2, further comprising a sleeve surrounding the housing and the nozzle assembly.

8. The mount of claim 3, wherein each of the housing and the nozzle assembly comprises a coaxially formed aperture, wherein a connection member is inserted into the aperture.

9. The mount of claim 8, wherein the first housing comprises a first inner core, wherein the aperture is formed in the first inner core, and
wherein the second housing is disposed with a gap from the first inner core and comprises a second inner core connected to the nozzle assembly by a contractable or expandable diaphragm.

10. The mount of claim 9, wherein the connection member is screwed to the second inner core.

11. The mount of claim 10, wherein the second inner core is configured to move toward the first inner core by screw coupling between the connection member and the second inner core.

12. The mount of claim 3, wherein the fluid is capable of flowing between the first housing and the second housing through the nozzle assembly.

13. A mount comprising:
a rubber bush mounted on a vehicle body of a vehicle; and
a hydro mass damper detachably coupled to the rubber bush, wherein the hydro mass damper is mounted on a structure to connect the structure to the vehicle body.

14. The mount of claim 13, wherein the vehicle body is a cross member of the vehicle, and the structure is a housing comprising a motor configured to drive the vehicle.

15. The mount of claim 13, further comprising a connection member configured to connect the rubber bush to the hydro mass damper.

16. The mount of claim 15, wherein the connection member is configured to penetrate the rubber bush and the hydro mass damper, and a first end of the connection member is configured to be screwed to the hydro mass damper.

17. The mount of claim 13, wherein the rubber bush is press-fitted into the vehicle body, and the hydro mass damper is press-fitted into the structure.

18. The mount of claim 13, wherein the hydro mass damper is configured to be non-rotatable with respect to the structure.

19. The mount of claim 18, wherein the structure comprise a non-curved surface in a portion coupled to the hydro mass damper, wherein the hydro mass damper comprises a flat surface mated with the non-curved surface.

20. A vehicle comprising the mount of claim 13.
